(19) United States
(12) Patent Application Publication
(10) Pub. No.: US 2025/0294643 A1
(43) Pub. Date: Sep. 18, 2025

(54) SYSTEMS AND METHODS FOR OPERATING AN OVEN APPLIANCE INCLUDING A COOKING ASSEMBLY

(71) Applicant: Haier US Appliance Solutions, Inc., Wilmington, DE (US)

(72) Inventors: Megan Hunter, Louisville, KY (US); Charles Andrew Bierbaum, Louisville, KY (US)

(21) Appl. No.: 18/606,611

(22) Filed: Mar. 15, 2024

(51) Int. Cl. H05B 1/02

(52) U.S. Cl. CPC H05B 1/0263

(57) ABSTRACT

A method for operating an oven appliance having a cooking assembly provided within a cooking chamber may include receiving an oven input indicative of an operation mode of the oven appliance. The method may also include determining a pre-heat temperature in response to receiving an input indicative of the operation mode. The method may also include performing a pre-heat sequence of the oven appliance based on the determined pre-heat temperature. The pre-heat sequence having a predetermined pre-heat condition. The method may further include detecting completion of the predetermined pre-heat condition. The method may further include initiating a user notification at a user interface in response to detecting completion of the predetermined pre-heat condition. The user notification may include an alert that the cooking assembly is preheated and ready to receive a food item to be cooked.

### FIELD OF THE DISCLOSURE

The present subject matter relates generally to an oven appliance and more particularly to a cooking assembly for an oven appliance.

### BACKGROUND OF THE DISCLOSURE

Conventional residential and commercial oven appliances generally include a cabinet that includes a cooking chamber for receipt of food items for cooking. Multiple heating elements are positioned within the cooking chamber to provide heat to food items located therein. In addition, conventional oven appliances include a cooktop positioned on a top of the appliance that includes one or more heating elements, such as electric heaters, gas burners, or induction heating elements. Cooking appliances that include both an oven and a cooktop are commonly referred to as “ranges.”

Oven appliances are often utilized in cooking large quantities or batches of food. However, further improvements are necessary to cook large quantities of certain foods, such as waffles or donuts, in the oven appliance. Particularly, these certain foods often require various accessories for cooking, e.g., waffle molds or donut molds. These accessories may present numerous challenges for a user. For example, these accessories may require unique cooking techniques that a user can be unaware of or lack expertise in. As another example, the accessories may make it difficult to achieve a desired bake reliably.

Accordingly, an oven appliance that obviates one or more of the above-mentioned features would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a method of operating an oven appliance is provided. The oven appliance may include a cooking assembly provided within a cooking chamber. The method may include receiving an oven input indicative of an operation mode of the oven appliance. The method may also include determining a pre-heat temperature in response to receiving an input indicative of the operation mode. The method may also include performing a pre-heat sequence of the oven appliance based on the determined pre-heat temperature. The pre-heat sequence having a predetermined pre-heat condition. The method may further include detecting completion of the predetermined pre-heat condition. The method may further include initiating a user notification at a user interface in response to detecting completion of the predetermined pre-heat condition. The user notification may include an alert that the cooking assembly is preheated and ready to receive a food item to be cooked.

In another exemplary aspect of the present disclosure, an oven appliance is provided. The oven appliance may include a cabinet defining a cooking chamber. The oven appliance may also include a cooking assembly positioned within the cooking chamber. The oven appliance may further include a controller operable for: receiving an oven input indicative of an operation mode of the oven appliance; determining a pre-heat temperature in response to receiving an input indicative of the operation mode; performing a pre-heat sequence of the oven appliance based on the determined pre-heat temperature, the pre-heat sequence having a predetermined pre-heat condition; detecting completion of the predetermined pre-heat condition; and initiating a user notification at a user interface in response to detecting completion of the predetermined pre-heat condition, wherein the user notification comprises an alert that the cooking assembly is preheated and ready to receive a food item to be cooked.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of an oven appliance according to an exemplary embodiment of the present subject matter.

FIG. 2 provides a side cross-sectional view of the exemplary oven appliance of FIG. 1 according to an exemplary embodiment of the present subject matter.

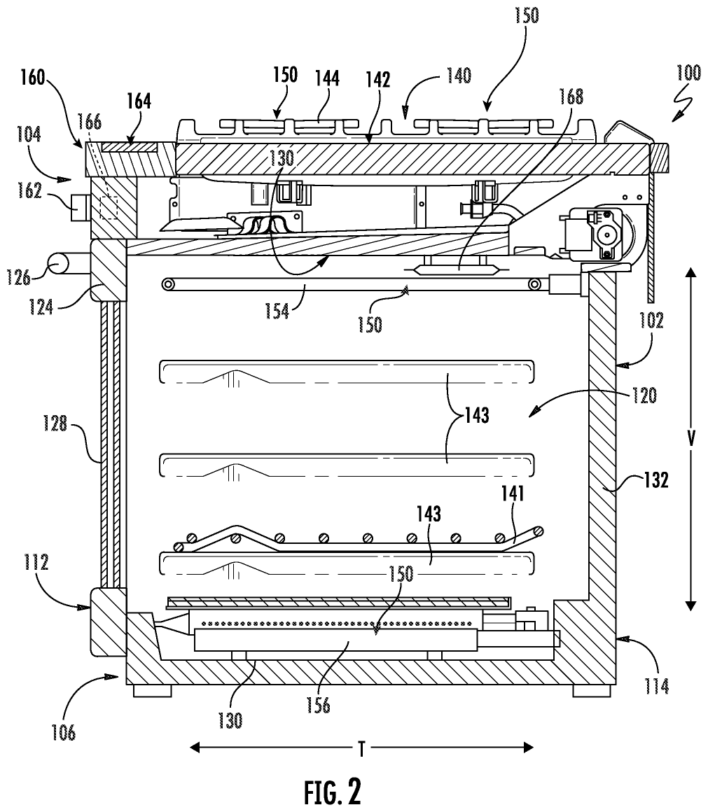

FIG. 3 provides a perspective view of an exemplary cooking assembly positioned within the exemplary oven appliance of FIG. 1 according to one or more exemplary embodiments of the present subject matter.

FIG. 4 provides a method of operating an oven appliance according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

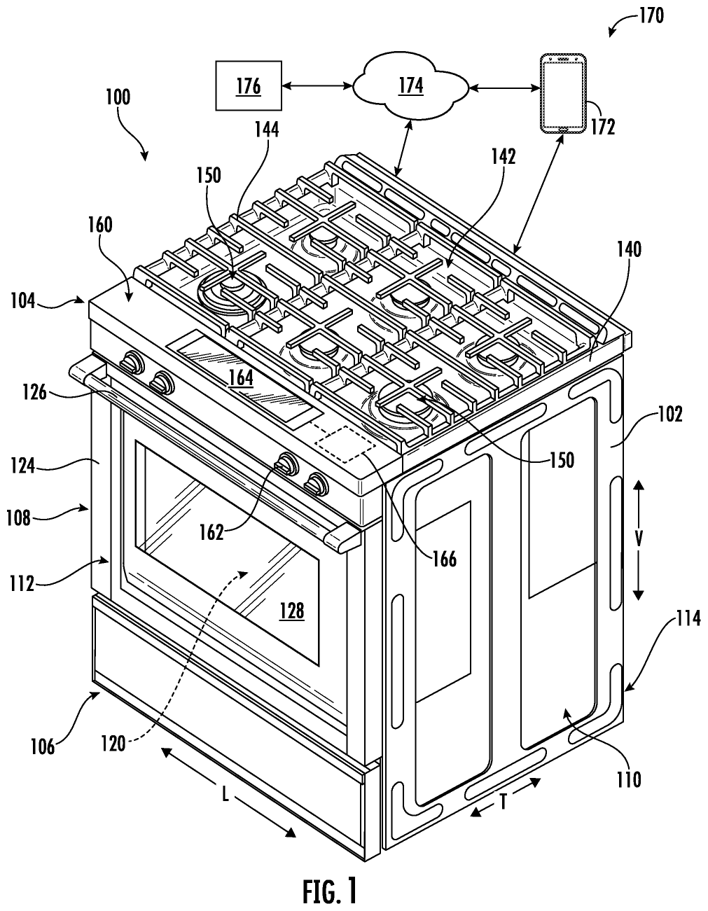

FIG. 1 provides a front, perspective view of an oven appliance 100 as may be employed with the present subject matter. Oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to display assemblies for any suitable appliance.

Oven appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

In general, cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

In some embodiments, one or more baking racks 141 are positioned in cooking chamber 120 for the receipt of food items or utensils containing food items. The one or more baking racks 141 may be slidably received onto embossed ribs or sliding rails 143 such that the one or more baking racks 141 may be conveniently moved into and out of cooking chamber 120 when door 124 is open. Additionally or alternatively, a cooking assembly 200 (e.g., described in more detail below) may be received onto one or more baking racks 141.

Oven appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. One or more grates 144 are supported on a top surface of top panel 142 for supporting cooking utensils, such as pots or pans, during a cooking process.

Oven appliance 100 may further include one or more heating elements (identified generally by reference numeral 150) for selectively heating cooking utensils positioned on grates 144 or food items positioned within cooking chamber 120. For example, referring to FIG. 1, heating elements 150 may be gas burners 150. Specifically, a plurality of gas burners 150 are mounted within or on top of top panel 142 underneath grates 144 that supports cooking utensils over the gas burners 150 while gas burners 150 provide thermal energy to cooking utensils positioned thereon, e.g., to heat food or cooking liquids (e.g., oil, water, etc.). Gas burners 150 can be configured in various sizes so as to provide e.g., for the receipt of cooking utensils (i.e., pots, pans, etc.) of various sizes and configurations and to provide different heat inputs for such cooking utensils. According to alternative embodiments, oven appliance 100 may have other cooktop configurations or burner elements.

In addition, heating elements 150 may be positioned within or may otherwise be in thermal communication with cooking chamber 120 for regulating the temperature within cooking chamber 120. Specifically, an upper gas heating element 154 (also referred to as a broil heating element or gas burner) may be positioned in cabinet 102, e.g., at a top portion of cooking chamber 120, and a lower gas heating element 156 (also referred to as a bake heating element or gas burner) may be positioned at a bottom portion of cooking chamber 120. Upper gas heating element 154 and lower gas heating element 156 may be used independently or simultaneously to heat cooking chamber 120, perform a baking or broil operation, perform a cleaning cycle, etc. The size and heat output of gas heating elements 154, 156 can be selected based on, e.g., the size of oven appliance 100 or the desired heat output. Oven appliance 100 may include any other suitable number, type, and configuration of heating elements 150 within cabinet 102 or on cooktop 140. For example, oven appliance 100 may further include electric heating elements, induction heating elements, or any other suitable heat generating device.

A control panel assembly 160 is located within convenient reach of a user of the oven appliance 100. For this example embodiment, control panel assembly 160 is positioned at a top 104 and front 112 of cabinet 102, e.g., above door 124 along the vertical direction V and forward of cooktop 140 along the transverse direction T. Control panel assembly 160 includes knobs 162 that are each associated with one of heating elements 150. In this manner, knobs 162 allow the user to activate each heating element 150 and determine the amount of heat input provided by each heating element 150 for cooking food items within cooking chamber 120 or on cooktop 140. Although shown with knobs 162, it should be understood that knobs 162 and the configuration of oven appliance 100 shown in FIG. 1 is provided by way of example only. More specifically, control panel assembly 160 may include various input components, such as one or more of a variety of touch-type controls, electrical, mechanical or electro-mechanical input devices including rotary dials, push buttons, and touch pads. Control panel assembly 160 may also be provided with one or more graphical display devices or display components, such as a digital or analog display device designed to provide operational feedback or other information to the user such as e.g., whether a particular heating element 150 is activated or the rate at which the heating element 150 is set. Indeed, according to the illustrated embodiment, control panel assembly 160 includes a display assembly 164, such as a liquid crystal display with an interactive display and interface.

Generally, oven appliance 100 may include a controller 166 in operative communication with control panel assembly 160. Control panel assembly 160 of oven appliance 100 may be in communication with controller 166 via, for example, one or more signal lines or shared communication busses, and signals generated in controller 166 operate oven appliance 100 in response to user input via user input devices, e.g., control knobs 162 or display assembly 164. Input/Output (“I/O”) signals may be routed between controller 166 and various operational components of oven appliance 100 such that operation of oven appliance 100 can be regulated by controller 166. In addition, controller 166 may also be in communication with one or more sensors, such as temperature sensor 168, which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog or digital logic circuitry (such as switches, amplifiers, integrators, comparators, flip-flops, AND gates, and the like) to perform control functionality instead of relying upon software.

Referring still to FIG. 1, a schematic diagram of an external communication system 170 will be described according to an exemplary embodiment of the present subject matter. In general, external communication system 170 is configured for permitting interaction, data transfer, and other communications between oven appliance 100 and one or more external devices. For example, this communication may be used to provide and receive operating parameters, user instructions or notifications, performance characteristics, user preferences, or any other suitable information for improved performance of oven appliance 100. In addition, it should be appreciated that external communication system 170 may be used to transfer data or other information to improve performance of one or more external devices or appliances or improve user interaction with such devices.

For example, external communication system 170 permits controller 166 of oven appliance 100 to communicate with a separate device external to oven appliance 100, referred to generally herein as an external device 172. As described in more detail below, these communications may be facilitated using a wired or wireless connection, such as via a network 174. In general, external device 172 may be any suitable device separate from oven appliance 100 that is configured to provide or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with oven appliance 100 or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control oven appliance 100, etc. In addition, external device 172 and remote server 176 may communicate with oven appliance 100 to communicate similar information.

In general, communication between oven appliance 100, external device 172, remote server 176, or other user devices or appliances may be carried using any type of wired or wireless connection and using any suitable type of communication network, non-limiting examples of which are provided below. For example, external device 172 may be in direct or indirect communication with oven appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Although aspects of the present subject matter are described herein in the context of a single oven appliance, it should be appreciated that oven appliance 100 is provided by way of example only. Other oven or range appliances having different configurations, different appearances, or different features may also be utilized with the present subject matter, e.g., double ovens, connected oven/cooktop units, etc. Moreover, aspects of the present subject matter are equally applicable to standalone cooktops (e.g., without cooking chambers) or other cooking appliances.

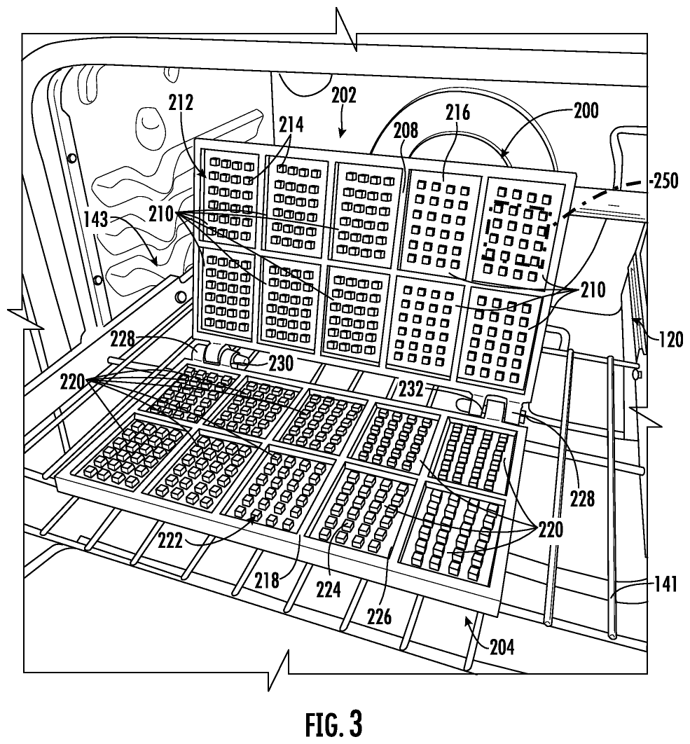

Referring now to FIG. 3, a cooking assembly 200 that may be used with oven appliance 100 will be described according to one or more exemplary embodiments of the present subject matter. Cooking assembly 200 may advantageously regulate heat levels within the cooking chamber 120. Additionally or alternatively, cooking assembly 200 may advantageously ensure consistent or accurate baking of food items placed within the cooking assembly 200. For example, the cooking assembly 200 may include a temperature sensor 250 (described in more detail below) that may measure temperature levels of the cooking assembly 200. The measured temperature levels of the cooking assembly 200 may be communicated to the controller 166 and may advantageously be utilized in regulating temperature levels within the cooking chamber 120 for the baking of food items. As another example, the cooking assembly 200 may advantageously include a plurality of mold bodies formed from a plurality of first mold bodies 210 and a plurality of second mold bodies 220, e.g., described in more detail below, for receiving uncooked food items (e.g., batter, dough, etc.) for baking. Additionally or alternatively, the cooking assembly 200 may advantageously facilitate the baking of large quantities of a food item at one time (e.g., relative to traditional standalone cooking or baking appliances such as waffle irons).

Although cooking assembly 200 is described herein as being used with oven appliance 100, it should be appreciated that cooking assembly 200 may be used with other cooking appliances while remaining within the scope of the present subject matter. For example, cooking assembly 200 may be used with a range oven appliance, a double oven appliance, an oven appliance having a different configuration, or within any other suitable cooking cavity. The example embodiment described herein is not intended to limit the scope of the present subject matter in any manner.

In some embodiments, cooking assembly 200 includes a first plate 202 and second plate 204. The first plate 202 may include an inner surface 208 and a plurality of first mold bodies 210. Each first mold body of the plurality of first mold bodies 210 may be recessed into the first plate 202 from the inner surface 208. In this regard, each first mold body of the plurality of first mold bodies 210 may define a first cavity 212 for receiving or molding uncooked food items (e.g., batter or dough). In some embodiments, each first mold body of the plurality of first mold bodies 210 includes one or more protruded elements 214 for forming or shaping the uncooked food item therewithin. For example, as illustrated in FIG. 3, each first mold body of the plurality of first mold bodies 210 includes one or more protruded elements 214 extended into the respective first cavity 212 from a bottom surface 216 thereof.

Similar to the first plate 202, the second plate 204 may include an inner surface 218 and a plurality of second mold bodies 220. Each second mold body of the plurality of second mold bodies 220 may be recessed into the second plate 204 from the inner surface 218 thereof. In this regard, each second mold body of the plurality of second mold bodies 220 may define a second cavity 222 for receiving or molding uncooked food items (e.g., batter or dough). In some embodiments, each second mold body of the plurality of second mold bodies 220 includes one or more protruded elements 224 for forming or shaping the uncooked food item therewithin. As illustrated in FIG. 3, each second mold body of the plurality of second mold bodies 220 includes a plurality of protruded elements 224 extended into the respective second cavity 222 from a bottom surface 226 thereof.

The first plate 202 and the second plate 204 may be coupled together via a hinge assembly 228. The hinge assembly 228 may include any suitable number of hinges positioned at any suitable location as to allow the first plate 202 or the second plate 204 to move, e.g., hinge, relative to the other plate. For example, a first hinge 230 and a second hinge 232 of the hinge assembly 228 may moveably couple the first plate 202 to the second plate 204. As illustrated, the first hinge 230 may be positioned at, or proximate to, a first lateral side of the cooking assembly 200. Additionally, the first hinge 230 may be positioned at a back side of the cooking assembly 200. The second hinge 232 may be positioned at, or proximate to, a second lateral side of the cooking assembly 200. Additionally, the second hinge 232 may be positioned at a back side of the cooking assembly 200. The first plate 202 or the second plate 204 may be moved or hinged (e.g., by a user lifting or moving the first plate 202 or the second plate 204 relative to the other plate 204 or 202) between an open position (e.g., FIG. 3) and a closed position.

In the open position, uncooked food items (e.g., batter, dough, etc.) may be placed (e.g., poured) into the plurality of first mold bodies 210 or the plurality of second mold bodies 220 for molding and baking. For example, in the exemplary embodiment depicted, uncooked food items may be placed into the plurality of second mold bodies 220, e.g., due to the positioning of the second plate 204 on the baking rack 141. Once the uncooked food items are placed into the plurality of first mold bodies 210 or the plurality of second mold bodies 220, the cooking assembly 200 may be moved to the closed position. For instance, the first plate 202 or the second plate 204 may be moved or hinged relative to the opposing plate such that the inner surface 208 of the first plate 202 and the inner surface 218 of the second plate 204 are interfaced. In the closed position, each first mold body of the plurality of first mold bodies 210 may align with a complementary second mold body of the plurality of second mold bodies 220 to form a food mold (e.g., a waffle mold, a donut mold, or any suitable type of food mold). The food mold may define a predetermined shape for the food item that is to be cooked (e.g., as a negative mold corresponding to the fully cooked food item). For example, as illustrated in FIG. 3, the cooking assembly 200 may define waffle shape for waffle batter that is to be cooked within the cooking assembly 200.

Additionally, the cooking assembly 200 may include a temperature sensor 250. In some embodiments, the temperature sensor 250 may be coupled to or embedded within the cooking assembly 200. For example, as illustrated in FIG. 3, the temperature sensor 250 may be embedded within the first plate 202. As used herein, “temperature sensor” or the equivalent is intended to refer to any suitable type of temperature measuring system or device positioned at any suitable location within the cooking assembly 200 for measuring the desired temperature. Thus, for example, temperature sensor may be any suitable type of temperature sensor, such as a thermistor, a thermocouple, a resistance temperature detector, a semiconductor-based integrated circuit temperature sensor, etc. In addition, temperature sensor may be positioned at any suitable location and may output a signal (e.g., wired or wirelessly), such as a voltage, to the controller 166 that is proportional to, or indicative of the temperature being measured. Although exemplary positioning of temperature sensor is described herein, it should be appreciated that cooking assembly 200 may include any other suitable number, type, and position of temperature, or other sensors according to alternative embodiments.

Although the cooking process described herein are discussed with respect to baked goods, such as waffles or donuts, it should be appreciated that the cooking process described herein may be used for any suitable food item. For example, in alternative exemplary embodiments, the cooking process described herein may be used for cooking or heating any suitable food item (e.g., cooked, or uncooked food items). For instance, in alternative exemplary embodiments, the first plate and the second plate may be configured as a griddle. In such embodiments, the cooking assembly may be utilized as a sandwich press, such as a panini press.

Now that the construction and configuration of oven appliance 100 has been described according to exemplary embodiments of the present subject matter, an exemplary method 300 for operating oven appliance 100 will be described according to an exemplary embodiment of the present subject matter. Method 300 can be used to operate oven appliance 100 or may be used to operate any other suitable oven appliances. In this regard, for example, controller 166 may be configured for implementing some or all steps of method 300. Further, it should be appreciated that the exemplary method 300 is discussed herein only to describe exemplary aspects of the present subject matter, and is not intended to be limiting.

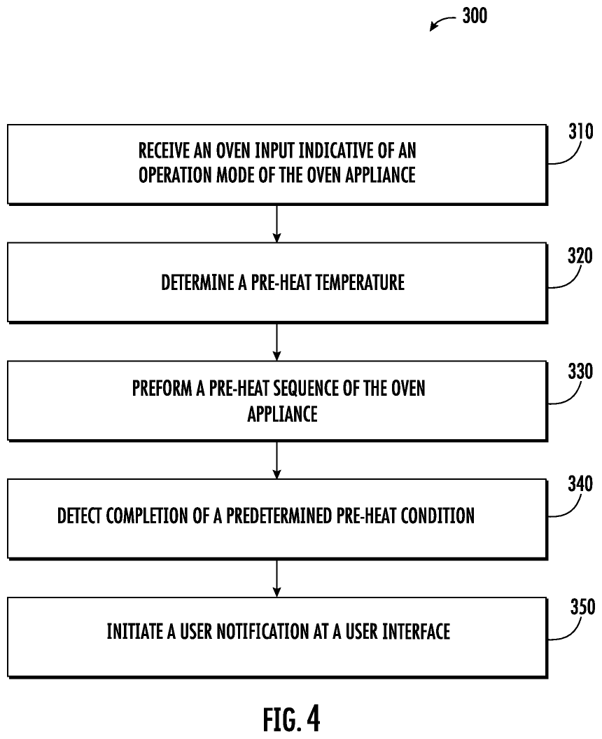

Referring now to FIG. 4, embodiments of the present subject matter may include one or more methods 300 of operating an oven appliance, such as the exemplary oven appliance 100 described above, as well as other possible exemplary oven appliances. The exemplary methods according to the present subject matter may include a method 300, for example, as illustrated in FIG. 4. A controller of the oven appliance, such as the controller 166 of the exemplary oven appliance 100, may be programmed to implement method 300, for example, the controller, such as controller 166, may be capable of and may be operable to perform any methods and associated method steps as disclosed herein.

Method 300, at 310, may include receiving an oven input indicative of an operation mode of the oven appliance. The oven input may be received in response to a manipulation of the control panel assembly, e.g., by a user of the oven appliance. In some embodiments, the oven input may be indicative of the food item to be cooked (e.g., food type). For example, a user may specify that waffles, donuts, sandwiches, etc., are to be cooked within a cooking assembly placed within a cooking chamber of the oven appliance. In this regard, the method 300, at 310, may further include receiving a food selection from a plurality of predetermined food options. The food selection may correspond to the food item to be cooked. Additionally or alternatively, in some embodiments, the oven input may be indicative of cooking preferences for the food item. For example, a user may specify their preference for how the food item is to be cooked, e.g., a predetermined texture profile of the cooked food item such as a crispy food item, soft food item, toasted food item, or any other suitable texture profile for a food item. In this regard, the method 300, at 310, may also include receiving a texture selection from a plurality of predetermined texture options. The texture selection may correspond to a cooking preference of the food item to be cooked. In some embodiments, the cooking preference may be defined by an amount of time that the food item is to be cooked (e.g., a cook time). Additionally or alternatively, in some embodiments, the cooking preference may be defined by a temperature of the cooking chamber during the cooking process.

Method 300, at 320, may include determining a pre-heat temperature in response to receiving an input indicative of the operation mode. For instance, based on the input indicative of the operation mode, e.g., based on the user selected cooking preferences or predetermined texture profile, a pre-heat temperature may be calculated or selected from a set of pre-calculated pre-heat temperatures stored within a memory of the controller. Following the determination of the pre-heat temperature, the method 300, at 330, may include performing a pre-heat sequence of the oven appliance based on the determined pre-heat temperature. Generally, the pre-heat sequence may be utilized to pre-heat the cooking chamber of the oven appliance and a cooking assembly that is positioned therewithin. In some embodiments, the pre-heat sequence includes a predetermined pre-heat condition. The predetermined pre-heat condition may be or include one or more actions that the oven appliance may complete in order to properly pre-heat the cooking assembly positioned within the oven appliance.

In some embodiments, the method 300, at 330, includes operating one or more heating elements at a first predetermined heat setting. In some embodiments, the first predetermined heat setting corresponds to a full or maximum heat setting of one or more heating elements positioned within the cooking chamber of the oven appliance. For example, operating the one or more heating elements at the first predetermined heat setting may include operating an upper gas heating element and a lower gas heating element at the highest heat setting, e.g., to quickly increase the temperature within the cooking chamber and the temperature of the cooking assembly. The method 300, at 330, may then include determining, via a temperature sensor within the cooking assembly, that the first predetermined temperature of the cooking assembly has been reached. For instance, the temperature sensor may measure the temperature of the cooking assembly (e.g., continuously or according to a predetermined interval). The temperature sensor may communicate the measured temperature (e.g., wirelessly or via a wired connection) to a controller of the oven appliance, wherein the measured temperature may be compared to the first predetermined temperature to determine when the first predetermined temperature has been met. In some embodiments, the first predetermined temperature may be lower than the pre-heat temperature. For example, in some embodiments, the first predetermined temperature may be approximately one to approximately seventy five percent lower than the pre-heat temperature. As another example, in some embodiments, first predetermined temperature may be approximately five to approximately fifty percent lower than the pre-heat temperature. As yet another example, in some embodiments, the first predetermined temperature may be approximately fifteen to approximately twenty five percent lower than the pre-heat temperature.

In response to determining that the first predetermined heat temperature has been reached, the method 300, at 330, may include reducing the heat setting of the one or more heating elements to a second predetermined heat setting. In some embodiments, the second predetermined heat setting is a lower heat setting for the one or more heating elements. For instance, the second predetermined heat setting may be less than or lower than the first predetermined heat setting. For example, the second predetermined heat setting may correspond to a half strength heat setting, e.g., a medium heat setting, of the one or more heating elements. Following reducing the heat setting of the one or more heating elements, the method 300, at 330, may include determining, via the temperature sensor, that the predetermined pre-heat temperature of the cooking assembly has been reached. Once the predetermined pre-heat temperature of the cooking assembly has been reached, the method 300, at 330, may include maintaining the predetermined pre-heat temperature.

Maintaining the predetermined pre-heat temperature may include detecting, via the temperature sensor, that a temperature of the cooking assembly is outside a pre-heat threshold of the predetermined pre-heat temperature. In some embodiments, the pre-heat threshold corresponds to a temperature range around the predetermined pre-heat temperature. For instance, the temperature range may define an upper and lower limit of a predetermined pre-heat range. If the temperature of the cooking assembly goes outside of this range, the method 300, at 330, may include adjusting the heat setting of the one or more heating elements in response to detecting the temperature of the cooking assembly is outside the pre-heat threshold. For instance, based on the temperature of the cooking assembly relative to the predetermined pre-heat temperature, adjusting the heat setting of the one or more heating elements may include raising the heat setting of the one or more heating elements or lowering the heat setting of the one or more heating elements.

Once the cooking assembly as reached the predetermined pre-heat temperature or after a predetermined amount of time of maintaining the predetermined pre-heat temperature, the method, at 340, may include detecting completion of the predetermined pre-heat condition. That is, after the predetermined pre-heat temperature has been met or maintained for a predetermined amount of time, the cooking assembly placed therewithin may be ready to receive a food item for cooking.

The method 300, at 350, may further include initiating a user notification in response to determining completion of the predetermined pre-heat condition. In some embodiments, initiating the user notification may include providing a user alert, e.g., text or sound, at the user interface panel of the oven appliance, for instance, to alert a user about the cooking assembly is preheated and ready to receive a food item to be cooked. In some other embodiments, initiating the user notification may include transmitting a push notification to an external device associated with the oven appliance. Transmitting the push notification may include delivering, via a network, information indicative of the completion of the predetermined pre-heat condition to the external device. For instance, the controller of the oven appliance may transmit a signal including information indicative of the completion of the predetermined pre-heat condition to the external device, and more particularly, to an associated application on the external device.

In some embodiments, the user notification may alert a user that a food item (e.g., an uncooked food item) may be positioned within the plurality of first mold bodies or the plurality of second mold bodies for cooking. After placing the food item into the plurality of first mold bodies or the plurality of second mold bodies, the cooking assembly may be moved to the closed position such that the food items are fully encapsulated within the food mold defined by the cooking assembly in the closed position. In some embodiments, the user notification may be provided on a user interface of the oven appliance. Additionally or alternatively, the user notification may be provided on a user interface of an external device.

The method 300 may include measuring, via the temperature sensor, a temperature profile of the cooking assembly. For instance, after the pre-heat sequence has been performed and the food item has been placed within the cooking assembly, the temperature sensor may (e.g., continuously or repeatedly) measure the temperature of the cooking assembly to form generate a temperature profile of the cooking assembly (e.g., as a graph of temperature over time). Based on the measured temperature profile of the cooking assembly or an amount of time elapsed since the measuring of the temperature profile, the method 300 may include determining a food item is cooked within the cooking assembly. For example, if the measured temperature profile is within the temperature range for a pre-determined amount of time it may be determined that a set or selected cook condition of the food item within the cooking chamber is met. As another example, if a predetermined amount of time has elapsed since the measuring of the temperature profile of the cooking assembly it may be determined that the set or selected cook condition of the food item within the cooking chamber is met. In some embodiment, the predetermined amount of time may correspond to a cooking time based on the operation mode of the oven appliance.

Additionally or alternatively, in response to determining that the set or selected cook condition of the food items within the cook assembly is met, the method 300 may include initiating a second user notification on the user interface. In some embodiments, initiating the second user notification may include providing a user alert, e.g., text or sound, at the user interface panel of the oven appliance, for instance, to alert or notify a user that the food items has been cooked to their desired preferences. In some other embodiments, initiating the second user notification may include transmitting a second push notification to an external device associated with the oven appliance. Transmitting the second push notification may include delivering, via a network, information indicative of the of the selected cook condition being met to the external device. For instance, the controller of the oven appliance may transmit a signal including information indicative of the selected cook condition being met to the external device, and more particularly, to an associated application on the external device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an oven appliance, the oven appliance comprising a cooking assembly provided within a cooking chamber, the method comprising:
receiving an oven input indicative of an operation mode of the oven appliance;
determining a pre-heat temperature in response to receiving an input indicative of the operation mode;
performing a pre-heat sequence of the oven appliance based on the determined pre-heat temperature, the pre-heat sequence having a predetermined pre-heat condition;
detecting completion of the predetermined pre-heat condition; and
initiating a user notification at a user interface in response to detecting completion of the predetermined pre-heat condition, wherein the user notification comprises an alert that the cooking assembly is preheated and ready to receive a food item to be cooked.

2. The method of claim 1, wherein receiving the oven input comprises:
receiving a food selection from a plurality of predetermined food options, the food selection corresponding to the food item to be cooked.

3. The method of claim 1, wherein receiving the oven input comprises:
receiving a texture selection from a plurality of predetermined texture options, the texture selection corresponding to a cooking preference of the food item to be cooked.

4. The method of claim 1, wherein the oven appliance comprises one or more heating elements, wherein the cooking assembly comprises a temperature sensor embedded therewithin wherein performing the pre-heat sequence comprises:
operating the one or more heating elements at a first predetermined heat setting;
determining, via the temperature sensor, that a first predetermined temperature has been reached, wherein the first predetermined temperature is lower than the pre-heat temperature;
reducing the heat setting of the one or more heating elements to a second predetermined heat setting in response to determining that the first predetermined temperature has been reached;
determining, via the temperature sensor, that a predetermined pre-heat temperature has been reached; and
maintaining the predetermined pre-heat temperature.

5. The method of claim 4, wherein maintaining the predetermined pre-heat temperature comprises:
detecting, via the temperature sensor, a temperature of the cooking assembly is outside a pre-heat threshold of the predetermined pre-heat temperature.

6. The method of claim 5, wherein maintaining the predetermined pre-heat temperature further comprises:
adjusting the heat setting of the one or more heating elements in response to detecting the temperature of the cooking assembly is outside the pre-heat threshold.

7. The method of claim 1, further comprising:
measuring, via a temperature sensor embedded within the cooking assembly, a temperature profile of the cooking assembly following performing the pre-heat sequence; and
determining a food item is cooked within the cooking assembly based on the temperature profile of the cooking assembly.

8. The method of claim 7, further comprising:
initiating a second user notification at the user interface in response to determining the food item is cooked within the cooking assembly.

9. The method of claim 8, wherein the user interface is a user interface of an external device in operative communication with a controller of the oven appliance.

10. An oven appliance comprising:
a cabinet defining a cooking chamber;
a cooking assembly positioned within the cooking chamber; and
a controller operable for:
receiving an oven input indicative of an operation mode of the oven appliance;
determining a pre-heat temperature in response to receiving an input indicative of the operation mode;
performing a pre-heat sequence of the oven appliance based on the determined pre-heat temperature, the pre-heat sequence having a predetermined pre-heat condition;
detecting completion of the predetermined pre-heat condition; and
initiating a user notification at a user interface in response to detecting completion of the predetermined pre-heat condition, wherein the user notification comprises an alert that the cooking assembly is preheated and ready to receive a food item to be cooked.

11. The oven appliance of claim 10, wherein receiving the oven input comprises:
receiving a food selection from a plurality of predetermined food options, the food selection corresponding to the food item to be cooked.

12. The oven appliance of claim 10, wherein receiving the oven input comprises:
receiving a texture selection form a plurality of predetermined texture options, the texture selection corresponding to a cooking preference of the food item to be cooked.

13. The oven appliance of claim 10, further comprising:
one or more heating elements positioned within the cooking chamber, wherein the cooking assembly comprises a temperature sensor embedded therewithin, and wherein performing the pre-heat sequence further comprises:
operating the one or more heating elements at a first predetermined heat setting;
determining, via the temperature sensor, that a first predetermined temperature has been reached, wherein the first predetermined temperature is lower than the pre-heat temperature;
reducing the heat setting of the one or more heating elements to a second predetermined heat setting in response to determining that the first predetermined temperature has been reached;
determining, via the temperature sensor, that a predetermined pre-heat temperature has been reached; and
maintaining the predetermined pre-heat temperature.

14. The oven appliance of claim 13, wherein maintaining the predetermined pre-heat temperature comprises:
detecting, via the temperature sensor, a temperature of the cooking assembly is outside a pre-heat threshold of the predetermined pre-heat temperature.

15. The oven appliance of claim 14, wherein maintaining the predetermined pre-heat temperature comprises:
adjusting the heat setting of the one or more heating elements in response to detecting the temperature of the cooking assembly is outside the pre-heat threshold.

16. The oven appliance of claim 10, wherein the cooking assembly comprises a temperature sensor embedded therewithin, and wherein the controller is further operable for:
measuring, via the temperature sensor, a temperature profile of the cooking assembly following heating the cooking chamber to the pre-heat temperature; and
determining the food item is cooked within the cooking assembly based on the temperature profile of the cooking assembly.

17. The oven appliance of claim 16, further comprising:
initiating a second user notification at the user interface in response to determining the food item is cooked within the cooking assembly.

18. The oven appliance of claim 17, wherein the user interface is a user interface of an external device in operative communication with the controller.

19. The oven appliance of claim 10, wherein the cooking assembly comprises a first plate, a second plate, and a hinge assembly, wherein the first plate and the second plate are coupled together via the hinge assembly, wherein the cooking assembly is moveable between an open position and a closed position.
